(19) United States
(12) Patent Application Publication
(10) Pub. No.: US 2004/0057158 A1
(43) Pub. Date: Mar. 25, 2004

(54) Method of depicting a pattern with electron beam and method of producing disc-like substrate carrying thereon a pattern depicted with electron beam

(75) Inventors: Toshihiro Usa, Kanagawa-ken (JP); Kazunori Komatsu, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/665,145

(22) Filed: Sep. 22, 2003

(30) Foreign Application Priority Data
Sep. 19, 2002 (JP) 272787/2002
Sep. 19, 2002 (JP) 272790/2002
Nov. 7, 2002 (JP) 323873/2002

(51) Int. Cl. G11B 5/82

(52) U.S. Cl. 360/135

(57) ABSTRACT

A resist layer formed on a disc-like substrate is exposed to an electron beam in a desired pattern to depict a desired pattern on the resist layer. The desired pattern is depicted by oscillating back and forth, in directions intersecting the circumferential direction of the disc-like substrate, an electron beam smaller in its beam diameter than the minimum width of the pattern while rotating the substrate in one direction.

### BACKGROUND OF THE INVENTION

1. Field of the Invention

This invention relates to a method of depicting a pattern with an electron beam and a method of producing a disc-like substrate for a high-density recording such as a master information carrier for magnetic transfer, an optical disc stamper and a patterned medium for high-density magnetic recording.

2. Description of the Related Art

There has been known magnetic transfer where the surface of a master information carrier having thereon an irregularity pattern of magnetic material representing information to be transferred is brought into close contact with a surface of a slave medium (a magnetic recording medium) having a magnetic layer and a transfer magnetic field is applied to the slave medium and the master information carrier in this state, thereby recording on the slave medium a magnetization pattern representing the information (e.g., a servo signal) on the master information carrier. See, for instance, Japanese Unexamined Patent Publication No.63(1988)-183623 and U.S. Pat. No. 6,347,016.

The master information carrier generally comprises a substrate and an irregularity pattern (a pattern of lands and grooves) of magnetic material formed on the substrate.

It has been expected that the master information carrier for magnetic transfer can be produced by the use of a method of producing an optical disc stamper, for producing optical discs, on the basis of a matrix carrying thereon an irregularity pattern of resist representing information to be transferred. (See, for instance, in U.S. Patent Laid-Open No. 20010028964.) Further, it is conceivable that the irregularity pattern of resist corresponding to the irregularity pattern on the substrate of the master information carrier for magnetic transfer can be depicted on the resist layer formed on a disc-like matrix by exposing the resist layer to a laser beam modulated according to information to be transferred while rotating the matrix in the same manner as the production of the optical disc matrix.

However, as the track width is narrowed (e.g., to not larger than 0.3 μm), for instance, to meet a demand for a higher recording density, the drawing diameter of a laser beam (the diameter at which a laser beam draws an image on the resist layer) comes not to be able to be thinned to draw a pattern of lands and grooves in such a narrow tracks. As a result, elements (the lands) of the irregularity pattern of resist come to have arcuate end portions and cannot be rectangular in shape. The element of the irregularity pattern on the master information carrier conforms to the element of the irregularity pattern of resist on the matrix in shape, especially in shape of the upper surface of the element. Accordingly, when the element of the irregularity pattern of resist on the matrix has end portions which are arcuate and not rectangular, the element of the irregularity pattern on the master information carrier also has end portions which are arcuate and not rectangular. Arcuate end portions of the lands of the irregularity pattern on the master information carrier result in incorrect formation of a magnetization pattern on the slave medium.

We, this applicant has proposed, in Japanese Patent Application 2002-202629, a method of depicting a pattern on the resist layer of the matrix by the use of an electron beam which is smaller in beam diameter than the laser beam.

In the method disclosed in Japanese Patent Application 2002-202629, an irregularity pattern is depicted on the resist layer with an electron beam whose diameter is smaller than the minimum width of the upper surface of the elements of the irregularity pattern, and the shape of the upper surface of each element is drawn by causing the electron beam to scan the resist layer a plurality of times. For example, in the case where the shape of the upper surface of each element of the irregularity pattern is of a rectangle perpendicular to the direction of recording tracks (the circumferential direction), the matrix is slightly rotated each time the electron beam scans the matrix in the direction perpendicular to the direction of recording tracks.

However, the method involving intermittent rotation of the matrix is disadvantageous in that it takes a very long time to depict a pattern.

Further, when the irregularity pattern includes an element which is a parallelogram having a slant side obliquely intersecting the direction of recording tracks in shape of its upper surface as well as an element the shape of the upper surface of which is of a rectangle perpendicular to the direction of recording tracks extending vertically to the same (e.g., a phase servo pattern), the slant side is zigzagged and cannot be precisely formed if the irregularity pattern is depicted by causing the electron beam to scan the resist layer a plurality of times in radial directions.

The slant side of the upper surface of the element which is a parallelogram in shape corresponds to a magnetization transition zone, and the linearity thereof, especially, within one track width, is very important upon reproduction of the signal.

Generally, a phase servo pattern includes an element which extends over a plurality of recording tracks and obliquely intersects the direction of recording tracks. There has not been established a method of precisely depicting such an element.

Also in the field of optical discs, it will become necessary to depict a pattern with an electron beam upon making a stamper in order to obtain a higher recording density.

It has been proposed to depict a pattern with an electron beam in production of a patterned medium realization of which has been expected as a high density magnetic recording medium which can be small in size and light in weight. See, for instance, Japanese Unexamined Patent Publication No. 2001-110050. However, in Japanese Unexamined Patent Publication No. 2001-110050, though use of an electron beam has been disclosed, how to depict a pattern with an electron beam has not been disclosed in detail.

### SUMMARY OF THE INVENTION

In view of the foregoing observations and description, the primary object of the present invention is to provide a method of depicting a desired pattern on a resist layer with an electron beam.

Another object of the present invention is to provide a substrate for producing a high density recording medium such as a master information carrier for magnetic transfer, an optical disc stamper, a patterned medium or the like, carrying thereon a pattern precisely depicted with an electron beam.

In accordance with a first aspect of the present invention, there is provided a method of exposing a resist layer formed on a disc-like substrate to an electron beam in a desired pattern to depict a desired pattern on the resist layer wherein the improvement comprises that the desired pattern is depicted by oscillating back and forth, in directions intersecting the circumferential direction of the disc-like substrate, an electron beam smaller in its beam diameter than the minimum width of the pattern while rotating the substrate in one direction.

In accordance with a second aspect of the present invention, there is provided a disc-like substrate for high-density recording produced by procedure including the steps of exposing a resist layer formed on the disc-like substrate to an electron beam in a desired pattern to depict a desired pattern on the resist layer and forming an irregularity pattern, wherein the improvement comprises that the desired pattern is depicted by oscillating back and forth, in directions intersecting the circumferential direction of the disc-like substrate, an electron beam smaller in its beam diameter than the minimum width of the pattern while rotating the substrate in one direction.

In accordance with a third aspect of the present invention, there is provided a method of producing a master information carrier for magnetic transfer having a substrate provided with an irregularity pattern formed of a plurality of elements at least one of which extends over a plurality of recording tracks intersecting the direction of the recording tracks, wherein the improvement comprises that

production of said substrate comprises the step of exposing a resist layer formed on a disc-like substrate to an electron beam to depict shapes of the upper surfaces of the elements, and

the shapes of the upper surfaces of the elements are depicted by parts in each of the recording tracks by oscillating back and forth, in directions intersecting the circumferential direction of the disc-like substrate, an electron beam smaller in its beam diameter than the minimum width of the pattern while rotating the substrate in one direction.

The term “desired pattern” as used herein may be those formed of concentrically or helically arranged elements of one or more bits or those including concentrically or helically extending long elements each corresponding to a plurality of short elements (grooves or lands). That is, the shape, the size and the arrangement of the pattern vary substrate by substrate, the pattern is depicted by depicting, for instance, individual elements forming the pattern.

The term “the minimum width of the pattern” as used herein means the smallest one of the distances between opposed sides of the elements in the desired pattern. For example, when the pattern is formed of elements which are substantially of a parallelogram (including a rectangle) in shape, then the minimum width of the pattern is the smallest distance in the distances between opposed parallel sides.

In the case where the shape of the element to be depicted is substantially of a parallelogram comprising two opposed sides extending along the concentric or helical recording tracks substantially in parallel to each other and two opposed sides extending in directions intersecting the recording tracks substantially in parallel to each other, generally the electron beam is caused to scan the resist layer substantially in parallel to the directions in which the two opposed sides extend to intersect the recording tracks substantially in parallel to each other. Further, in order to depict such a parallelogram the electron beam is oscillated back and forth in a constant distance. In this case, the “directions intersecting the circumferential direction of the disc-like substrate” in which the electron beam is oscillated back and forth should be controlled taking into account rotation of the disc-like substrate so that the electron beam comes to scan the disc-like substrate in a desired direction. The circumferential direction of the disc-like substrate is substantially equal to the direction in which the disc-like substrate is rotated.

The disc-like substrate may be a substrate for producing, for instance, a master information carrier for magnetic transfer, an optical disc stamper, a patterned medium for high-density magnetic recording, or the like.

The master information carrier carries on its substrate a magnetic layer in a pattern representing information to be transferred to a slave medium. The disc-like substrate on which a desired pattern is depicted with an electron beam may be the substrate of a master information carrier or a matrix on the basis of which master information carriers are produced. Further, the information to be transferred to the slave medium includes a servo signal. The magnetic layer is formed on the disc-like substrate according to the depicted pattern.

The “magnetic layer in a pattern” may be formed either along only the upper surface of lands (protruding portions) of an irregularity pattern formed on the substrate or along an irregularity pattern formed on the substrate. Alternatively, the “magnetic layer in a pattern” may be formed by embedding magnetic material in grooves (recessed portions) of an irregularity pattern formed on the substrate. Further, the “magnetic layer in a pattern” may be a magnetic layer which is formed on a flat substrate and is provided with an irregularity pattern or may comprise a plurality of magnetic layers provided on a flat substrate independently of each other. In the case where a substrate having an irregularity pattern on its surface is formed of a magnetic material, the irregularity pattern itself may be the “magnetic layer in a pattern” and the substrate itself may be a master information carrier. However, also in this case, it is preferred that a magnetic layer be formed on the substrate. As the magnetic layer, those formed of soft or semi-hard magnetic material be preferred.

The magnetic layer in a pattern of a master information carrier is formed according to said desired pattern and the pattern formed by the upper surfaces of the protruding portions (lands) of the irregularity pattern or by the openings of the recessed portions (grooves) of the irregularity pattern corresponds to the desired pattern. The individual upper surfaces of the protruding portions (lands) of the irregularity pattern or the openings of the recessed portions (grooves) of the irregularity pattern correspond to the individual elements of the desired pattern.

The “optical disc stamper” is a substrate carrying on its surface an irregularity pattern representing information to be transferred to optical discs. The disc-like substrate on which a desired pattern is depicted with an electron beam may be an optical stamper itself or a matrix on the basis of which optical stampers are produced.

The irregularity pattern on the disc-like substrate includes so-called lands, pits, and grooves, and is formed according to said desired pattern. Here the pattern formed by the upper surfaces (openings) of the pits and the grooves corresponds to the desired pattern.

The “patterned medium” is a high-density magnetic recording medium and comprises finely divided magnetic particles each forming a single magnetic domain regularly arranged physically isolated from each other so that one bit is recorded on one finely divided magnetic particle as disclosed in Japanese Unexamined Patent Publication No. 2001-110050. The disc-like substrate on which a desired pattern is depicted with an electron beam may be the substrate of a patterned medium or a matrix on the basis of which patterned media are produced. In the patterned medium, the single magnetic domain finely divided particles are formed according to the desired pattern, and the upper surfaces of the single magnetic domain finely divided particles correspond to the individual elements of the desired pattern.

The expression “an element which extends over a plurality of recording tracks intersecting the direction of the recording tracks” means a protruding portion whose upper surface is substantially of a parallelogram extending over a plurality of recording tracks intersecting the direction of the recording tracks or a recessed portion having an opening which is substantially of a parallelogram extending over a plurality of recording tracks intersecting the direction of the recording tracks. Accordingly, the shape of the upper surface of the element is substantially a parallelogram and as used here, “the shape of the upper surface of the element” includes the shape of the opening of the recessed portion. One pair of opposed parallel sides of the parallelogram extend substantially along the recording tracks and the other pair of opposed parallel sides of the parallelogram extend to intersect the recording tracks. When the other pair of opposed parallel sides are perpendicular to the recording tracks, the parallelogram becomes a rectangle which is a kind of parallelogram. An irregularity pattern representing a phase servo signal can include an element which extends over a plurality of recording tracks intersecting the direction of the recording tracks. However, an irregularity pattern representing a phase servo signal also includes elements which are substantially of a rectangle whose length is smaller than a track width.

That is, in accordance with the third aspect of the present invention, “the shape of the upper surface of the element which extends over a plurality of recording tracks intersecting the direction of the recording tracks” is divided into a plurality of parallelogram sections each in one track, and “the shape of the upper surface of the element which extends over a plurality of recording tracks intersecting the direction of the recording tracks” is depicted by repeating depictions of the parallelogram sections. Each of the parallelogram sections is depicted by oscillating the electron beam back and forth in a constant distance while rotating the disc-like substrate.

In accordance with the method of the first aspect of the present invention, each pattern can be depicted at a speed much higher than the conventional method where the disc-like substrate is intermittently rotated.

Further, there has been a problem that when an element having a slant side obliquely intersecting the direction of recording tracks in shape of its upper surface, the slant side is zigzagged if the element is depicted by causing the electron beam to scan the resist layer a plurality of times in parallel to the direction of the recording tracks or radial directions perpendicular to the direction of the recording tracks as in the prior art described above. Whereas, in accordance with the method of the first aspect of the present invention, since the electron beam comes to scan in the direction of the slant side obliquely intersecting the direction of recording tracks, the slant side can be substantially linear and the pattern can be excellently depicted.

The disc-like substrate in accordance with the second aspect of the present invention can carry a desired pattern which has been precisely depicted.

When the disc-like substrate is employed to produce an optical disc stamper, optical discs such as CDs or DVDs which are improved in production properties can be obtained.

When the disc-like substrate is employed to produce a patterned medium, a patterned medium having a precisely arranged high-density pattern can be obtained.

In accordance with the method of the third aspect of the present invention, the element which extends over a plurality of recording tracks intersecting the direction of the recording tracks can be depicted without complicating control of the electron beam.

For example, when a parallelogram which extends over a plurality of recording tracks intersecting the direction of the recording tracks is depicted by oscillating back and forth an electron beam along the slant sides of the parallelogram extending over a plurality of recording tracks at an amplitude equal to the length of the slant sides, control of the electron beam is complicated since a phase servo signal generally includes elements shorter than one track width in addition to an element which extends over a plurality of recording tracks obliquely intersecting the direction of the recording tracks. Whereas, in accordance with the method of the third aspect of the present invention, since a parallelogram is depicted recording track by recording track, control of the electron beam cannot be complicated.

Further, there has been a problem that when an element having a slant side obliquely intersecting the direction of recording tracks in shape of its upper surface, the slant side is zigzagged if the element is depicted by causing the electron beam to scan the resist layer a plurality of times in parallel to the direction of the recording tracks or radial directions perpendicular to the direction of the recording tracks as in the prior art described above. When the slant side of an element, especially an element depicted within one recording track, is zigzagged in a master information carrier for magnetic transfer, there is a fear that the signal reproducibility in a slave medium deteriorates. Whereas, in accordance with the method of the third aspect of the present invention, since the electron beam comes to scan in the direction of the slant side obliquely intersecting the direction of recording tracks, the slant side can be substantially linear and the pattern can be excellently depicted.

### BREIF DESCRIPTION OF THE DRAWINGS

FIGS. 1A to 1C are views for illustrating formation of an irregularity pattern on a matrix for producing a master information carrier,

FIG. 2 is an enlarged plan view showing a part of the pattern to be depicted in one recording track on the surface of the substrate in accordance with an embodiment of the present invention,

FIG. 3A is a fragmentary side view showing an electron beam projecting unit employed,

FIG. 3B is a plan view of the electron beam projecting unit,

FIG. 4 is a schematic view illustrating a method of drawing the elements obliquely intersecting X-direction,

FIGS. 5A to 5D are views showing methods of depicting parallelograms having slant sides respectively extending from the origin to the first to fourth quadrants in an X-Y coordinate system with the depiction starting point positioned on the origin,

FIGS. 6A to 6D are views for illustrating production of a master information carrier by the use of the matrix on which a desired pattern has been depicted in accordance with the method of the present invention,

FIGS. 7A to 7C are views for illustrating the basic steps of magnetic transfer,

FIGS. 8A to 8C are views for illustrating formation of an irregularity pattern on a matrix for producing an optical disc stamper in accordance with another embodiment of the present invention,

FIG. 9 is a view showing the optical disc stamper and showing a part of the same in an enlarged scale,

FIG. 10 is a view showing a patterned medium and showing a part of the same in an enlarged scale to be produced in accordance with still another embodiment of the present invention,

FIG. 11 is an enlarged plan view showing a part of the pattern to be depicted on the surface of the substrate in accordance with still another embodiment of the present invention, and

FIG. 12 is a schematic view illustrating a method of drawing the elements shown in FIG. 11.

### DESCRIPTION OF THE PREFERRED EMBODIMENT

A method of producing a substrate of a master information carrier for magnetic transfer in accordance with an embodiment of the present invention will be described, hereinbelow.

The pattern to be depicted here is according to an irregularity pattern to be formed on the substrate of the master information carrier, and upper surfaces of the protruding portions of the irregularity pattern or openings of recessed patterns of the irregularity pattern are elements to be depicted.

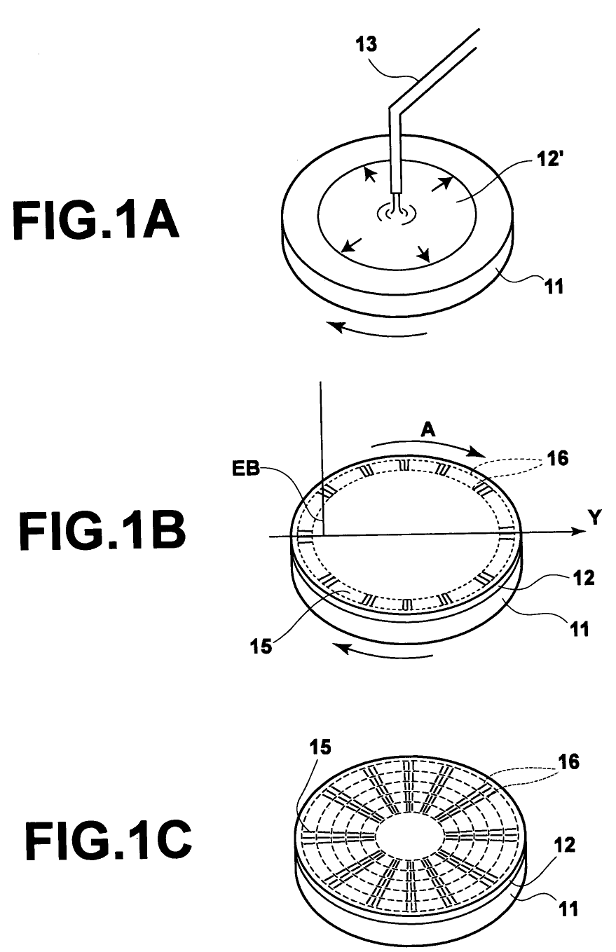

As shown in FIG. 1A, for example, a resist solution 12′, comprising a positive-type electron beam drawing resist 12 dissolved in an organic solvent, is applied to a disc-like substrate 11 of silicon, glass or quartz by spin coating from a nozzle 13 while rotating the disc-like substrate 11 in one direction and then the substrate 11 is baked.

Thereafter, as shown in FIG. 1B, an electron beam EB modulated according to information to be transferred such as a servo signal is caused to scan the disc-like substrate 11 carrying thereon the resist 12 while rotating the substrate in the direction of arrow A, thereby drawing (depicting) a desired pattern recording track by recording track. The direction A of rotation of the disc-like substrate 11 may be regarded as a direction X substantially perpendicular to a diametrical direction Y when microscopically viewed element by element. The direction X is a circumferential direction or a direction of recording tracks.

Then, as shown in FIG. 1C, the positive electron beam drawing resist 12 is developed and a disc-like substrate 11 on which a desired pattern 15 is drawn along concentric circles 16 is obtained.

The pattern 15 shown in FIG. 1C is a pattern according to a servo signal recorded in servo signal areas concentrically formed at predetermined intervals.

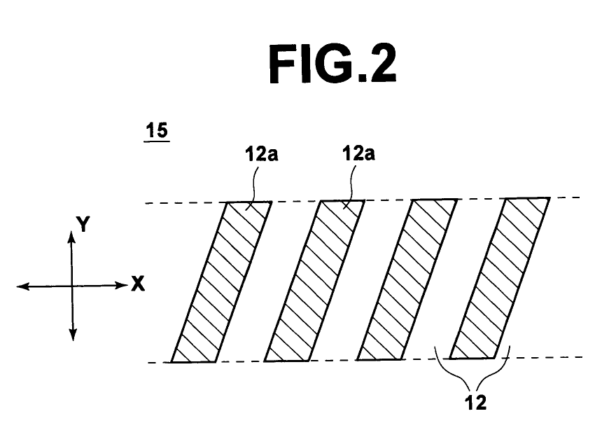

FIG. 2 is an enlarged plan view showing a part of the pattern 15 to be depicted in one recording track on the surface of the substrate 11. The pattern 15 includes elements 12a which extend obliquely intersecting the direction X of the recording tracks (circumferential direction). In FIG. 2, the hatched portions correspond to the elements 12a depicted with the electron beam (exposed to the electron beam). The elements 12a are substantially of a parallelogram having slant sides at angle θ to the direction X of the recording tracks. The areas exposed to the electron beam such as the elements 12a are removed with the resist 12 upon development and from recessed portions. This substrate 11 forms a matrix from which master information carriers are duplicated.

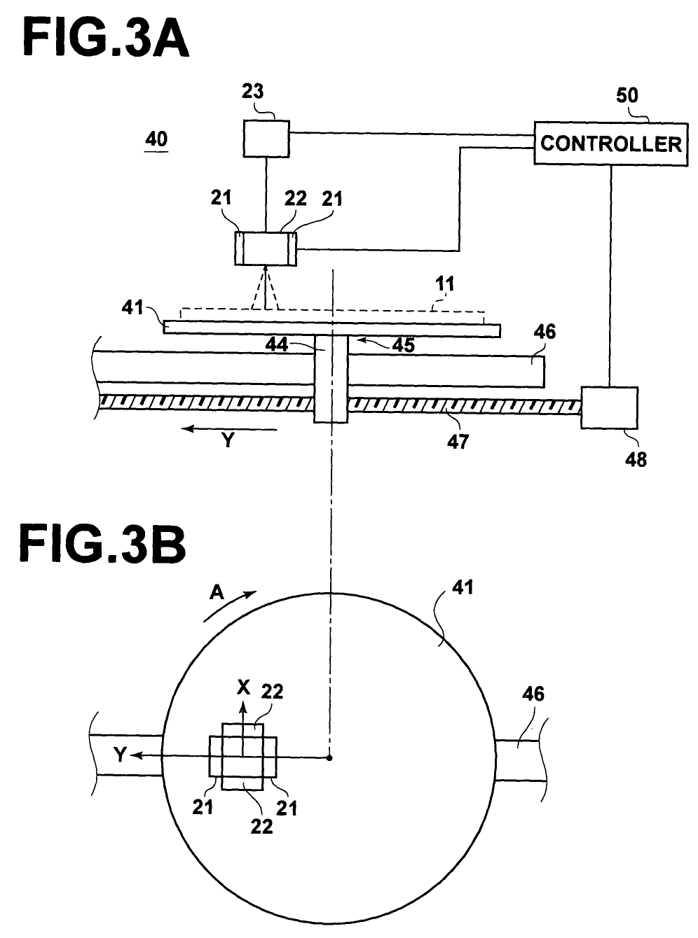

FIG. 3A is a fragmentary side view showing an electron beam projecting unit employed in this embodiment, and FIG. 3B is a plan view of the same. The electron beam projecting unit 40 comprises a pair of deflector means 21 and 22 which deflect an electron beam EB emitted from an electron gun 23 respectively in Y-direction (the direction of recording tracks) and X-direction (the circumferential direction), and the electron beam EB emitted from the electron gun 23 is projected onto the disc-like substrate 11 by way of deflector means 21 and 22, a lens (not shown) and the like with a beam diameter smaller than the minimum width of the elements. When the elements are depicted, the electron beam EB are finely oscillated at a predetermined amplitude in a predetermined direction intersecting X-direction of the substrate 11 by the deflector means 21 and 22.

Further, the electron beam projecting unit 40 comprises a rotary stage unit 45 including a circular stage 41 which supports the disc-like substrate 11 and a spindle motor 44 having a motor shaft coaxial with the central axis of the circular stage 41, a shaft 46 which extends through a part of the rotary stage unit 45 in a radial direction of the circular stage 41 (Y-direction) and a moving means which is for moving the rotary stage unit 45 along the shaft 46 and includes a threaded rod 47 extending in parallel to the shaft 46 in mesh with a part of the rotary stage unit 45 and a pulse motor 48 which rotates the threaded rod 47 in regular and reverse directions. A controller 80 controls drive of the pulse motor 48, modulation of the electron beam EB and deflector means 21 and 22.

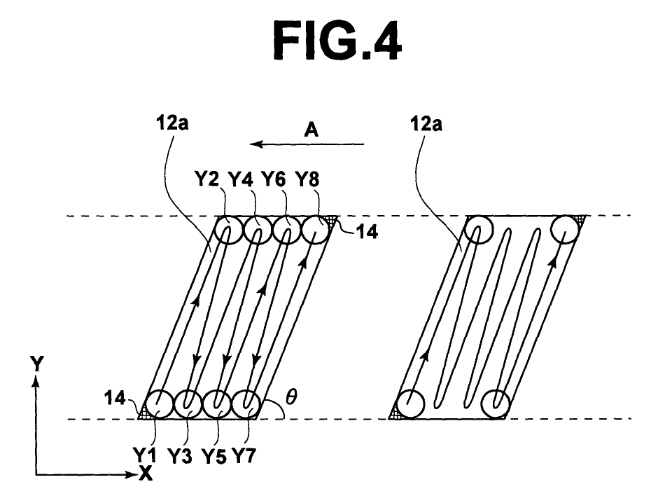

A method of drawing the elements 12a, obliquely intersecting X-direction, which can be employed in this embodiment will be described with reference to FIG. 4, hereinbelow. The elements 12a which are substantially parallelogram in shape are drawn, for instance, by periodically oscillating the electron beam EB in a predetermined direction at a predetermined amplitude by driving the Y-direction deflector means 21 and the X-direction deflector means 22 in synchronization with each other by periodic function signals such as of a sine wave while rotating the disc-like substrate 11 in the direction of arrow A so that the electron beam EB scans the resist 12 on the disc-like substrate 11 in parallel to the slant sides of the element 12a at angle θ to the direction of arrow A.

That is, the electron beam EB is caused to scan the resist 12 from point Y1 to point Y2, from point Y2 to point Y3, from point Y3 to point Y4 • • • in sequence and one element 12a is thus depicted. At this time, the Y-direction deflector means 21 and the X-direction deflector means 22 are controlled to control the direction in which the electron beam EB is oscillated. The rotating speed of the disc-like substrate 11 is controlled so that the point on which the electron beam EB is projected is moved from point Y1 to point Y3 in one cycle of the oscillation of the electron beam EB, and the direction in which the electron beam EB is oscillated is determined taking into account the movement of the point on which the electron beam EB is projected in X-direction due to rotation of the disc-like substrate 11. After a pattern for one recording track is depicted, the rotary stage unit 45 is moved and a pattern for an adjacent recording track is depicted.

The cross-hatched portions 14 in FIG. 4 are not exposed to the electron beam EB and corners of the parallelogram element 12a are rounded though they should be pointed. Such rounded corners result in recording loss and in order to reduce this, it is effective to reduce the diameter of the electron beam EB and to increase the number of times of scanning, which may be suitably set taking into account the efficiency in depicting the pattern. It is believed that linearity of the slant sides intersecting the direction of the recording tracks is very important in the area of the recording tracks where the magnetic head runs but influence thereof is relatively small in edges of the recording tracks.

In the method of this embodiment, the electron beam EB is caused to scan the disc-like substrate 11 along the slant sides of the element intersecting the direction of the recording tracks, the slant sides of element are substantially linearly depicted. When a master information carrier having such a substrate is used, the linearity of the magnetization transition zone of the transfer pattern is improved.

It is preferred that the output power and the beam diameter be controlled taking into account the shapes of the elements and the sensitivity of the electron beam drawing resist.

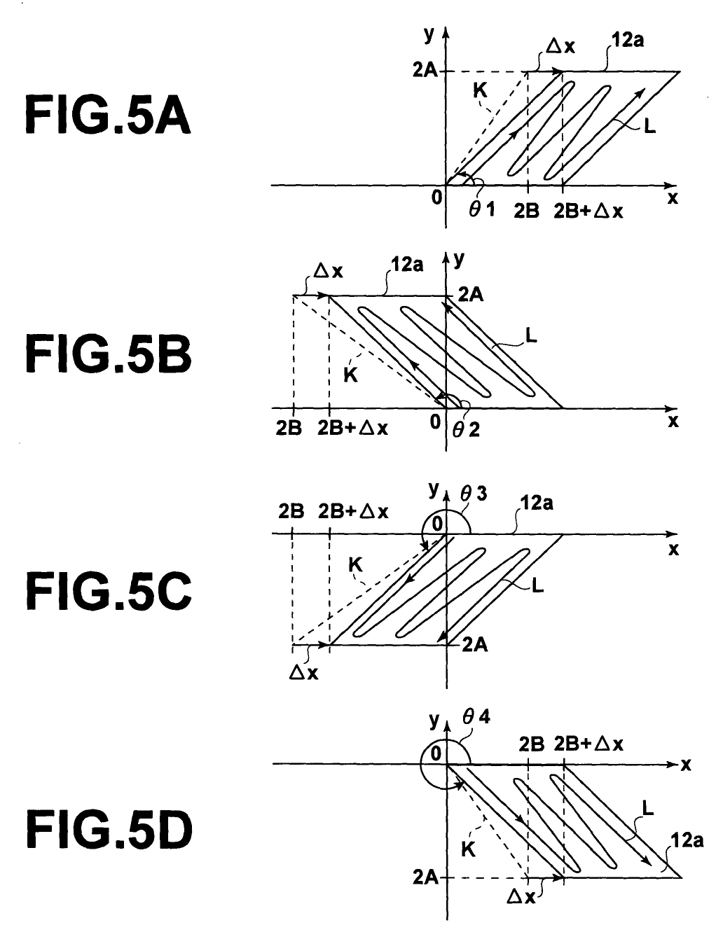

An example of the method of controlling the direction of oscillation of the electron beam EB so that the electron beam EB scans the resist 12 on the disc-like substrate 11 in parallel to the slant sides of the element 12a at angle θ to the direction of recording tracks will be described with reference to FIGS. 5A to 5D, hereinbelow.

FIGS. 5A to 5D are views showing methods of depicting parallelograms having slant sides respectively extending from the origin to the first to fourth quadrants in an X-Y coordinate system with the depiction starting point positioned on the origin. In FIGS. 5A to 5D, θ1 to θ4 denotes the inclinations of the slant side.

In this embodiment, as the periodic functions for periodically displacing the electron beam EB in Y-direction and X-direction, sine waves y=A sin (ωt+α), x=B sin(ωt+β) are employed, wherein A and B respectively represent amplitudes, α and β respectively represent phases, ω=2πf and f represents a frequency of the periodic functions, and when the phases α and β satisfy |β−α|=nπ, the trajectory of the electron beam EB is a straight line K whose inclination is A/B in the X-Y coordinate system so long as the disc-like substrate 11 is held stationary, and the point on which the electron beam EB is projected is simply oscillated along the straight line K. When the elements are depicted, projection of the electron beam EB is started in a position in which the amplitude of the simple oscillation is maximized or minimized and is terminated in a position in which the amplitude of the simple oscillation is minimized or maximized and the phase is shifted by π from the starting position.

On the other hand, as the circular stage is rotated, the point on which the electron beam EB is projected (will be referred to as “the beam projecting point”, hereinbelow) is displaced in the circumferential direction as compared with the disc-like substrate 11 is held stationary. When the linear velocity of the circular stage on the beam projecting point is represented by v, the distance Δx by which the beam projecting point is shifted in the circumferential direction x due to rotation of the stage in a half ½f of the period of the periodic functions is represented by Δx=v/2f. In order to set the amplitude B taking into account the distance Δx, the inclination θ (θ1 to θ4) of the slant side of each of the parallelograms shown in FIGS. 5A to 5D to the direction of recording tracks (the circumferential direction) should satisfy formula tan θ=2A/(2B+Δx). That is, when a parallelogram of a desired inclination θ is to be depicted, the amplitudes A and B are set to satisfy formula tan θ=2A/(2B+Δx). The inclination θ of a parallelogram is an inclination to a circumferential straight line passing through the origin with the depiction starting point positioned on the origin, and 0<θ<2π (θ≠π).

That is, the electron beam EB is oscillated along a straight line K shown by the broken line which extends from the origin at a predetermined inclination. The straight line K shows the trajectory of the electron bean EB in the case where the disc-like substrate 11 is held stationary. Though the electron beam EB is oscillated along the straight line K, the electron beam EB depicts a trajectory L on the substrate 11 since the substrate 11 is rotated in −X-direction.

Examples of the method of depicting parallelograms shown in FIGS. 5A and 5B will be given, hereinbelow. When the parallelogram shown in FIG. 5A is to be depicted assuming that α=β=−π/2 and θ1=45°, the amplitudes A and B are set so that tan θ1=2A/(2B+Δx)=1 (i.e., 2A=2B+Δx) is satisfied.

When the parallelogram shown in FIG. 5B is to be depicted assuming that α=−π/2, β=π/2, and θ2=135°, the amplitudes A and B are set so that tan θ2=2A/(2B+Δx)=−1 (i.e., 2A=−(2B+Δx)) is satisfied.

The parallelogram shown in FIG. 5C can be depicted by taking θ3=π+θ1 in the method of depicting the parallelogram shown in FIG. 5A. The parallelogram shown in FIG. 5D can be depicted by taking θ4=π+θ2 in the method of depicting the parallelogram shown in FIG. 5B.

Though, in the example described above, sine waves are employed as the periodic functions for periodically displacing the electron beam EB, the periodic functions may be various functions such as those which makes the trajectory of the electron beam a square wave, a pulse wave and a triangular wave.

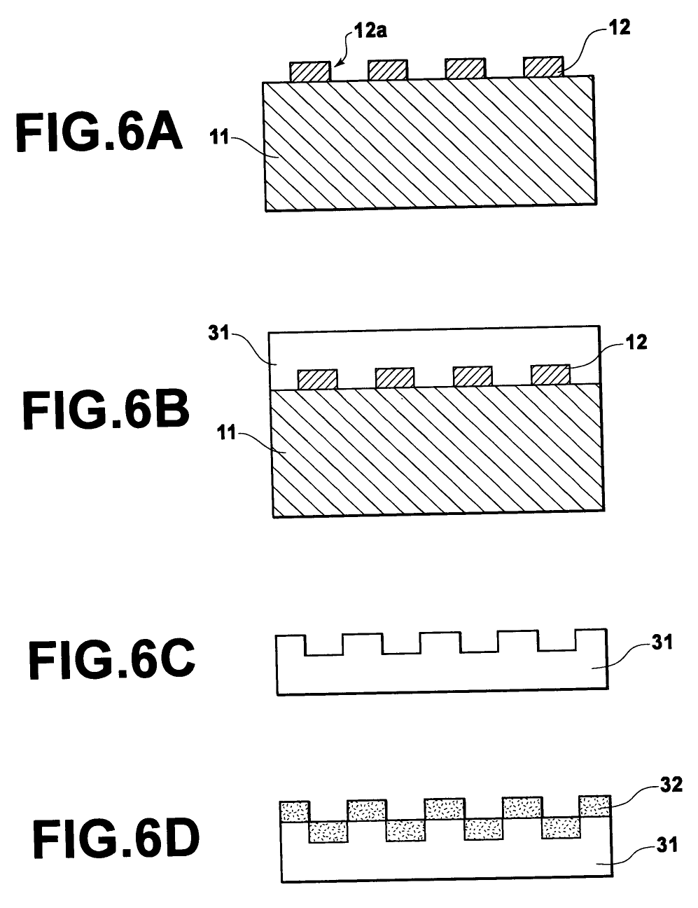

Production of a master information carrier by the use of a matrix produced in the manner described above will be described with reference to FIGS. 6A to 6D, hereinbelow.

As shown in FIG. 6A, a desired pattern is drawn on a electron beam drawing resist 12 on the substrate 11 by projecting an electron beam EB in the manner described above and the resist 12 in the area 12a exposed to the electron beam EB is removed by developing the resist, whereby a matrix carrying thereon an irregularity pattern of the resist 12 is obtained.

Then a thin conductive layer is formed on the surface of the matrix and electroforming is applied to the thin conductive layer, whereby a metal substrate 31 having a positive irregularity pattern following the matrix is obtained as shown in FIG. 6B.

Thereafter, the metal substrate 31 in a predetermined thickness is peeled off the matrix as shown in FIG. 6C.

After the backside of the metal substrate 31 is polished, the metal substrate 31 may be used as a master information carrier, or the metal substrate 31 provided with a soft magnetic layer 32 on the surface of irregularity pattern as shown in FIG. 6D may be used as a master information carrier.

Otherwise, the matrix may be plated to form a second matrix and the second matrix may be plated to form a metal substrate having a negative irregularity pattern. Further, a third matrix may be formed by plating the second matrix or pressing a resin syrup against the surface of the second matrix and curing the resin syrup, and a substrate having a positive irregularity pattern may be formed by plating the third matrix.

Whereas, after the resist 12 in the exposed area is removed by development, the disc-like substrate 11 selectively covered with the resist 12 left thereon may be etched and a matrix may be obtained by removing the resist 12 after etching. Thereafter, a substrate 31 can be obtained from the matrix in the same manner as described above.

In any case, the protruding portions or the recessed portions forming the irregularity pattern on the substrate 31 depend on the irregularity pattern of the resist on the matrix in their shape. As described above, when the irregularity pattern on the matrix is formed, substantially parallelogram elements are depicted by oscillating the electron beam EB in the direction of the slant sides and accordingly the slant sides of the element are linearly depicted, whereby a substrate carrying thereon an irregularity pattern which is straight in the slant sides of the upper surface of the protruding portions can be obtained.

The metal substrate 31 may be formed of Ni or Ni alloys. The metal substrate 31 may be formed by various metal film forming techniques including electroless plating, electroforming, sputtering, and ion plating. The depth of the irregularity pattern (the height of the protruding portions) of the metal substrate 31 is preferably 80 nm to 800 nm, and more preferably 150 nm to 600 nm.

The magnetic layer 32 is formed by forming film of a magnetic material by, for instance, by vacuum film forming techniques such as sputtering or ion plating or plating. As the magnetic material, Co, Co alloys (e.g., CoNi, CoNiZr, or CoNbTaZr), Fe, Fe alloys (e.g., FeCo, FeCoNi, FeNiMo, FeAlSi, FeAl, or FeTaN), Ni or Ni alloys (e.g., NiFe) can be employed. FeCo and FeCoNi are especially preferred. The thickness of the magnetic layer 32 is preferably 50 nm to 500 nm, and more preferably 100 nm to 400 nm.

A master information carrier may be formed by forming a resin substrate by the use of the matrix produced in the manner described above and providing a magnetic layer on the surface of the resin substrate. As the material of the resin substrate, acrylic resin such as polycarbonate or polymethyl methacrylate, vinyl chloride resin such as polyvinyl chloride, or vinyl chloride copolymer, epoxy resin, amorphous polyolefin, polyester or the like may be used. Among those, polycarbonate is preferred in view of the humidity resistance, dimensional stability, cost and/or the like. Flash on the product should be removed by varnishing or polishing. Otherwise, ultraviolet curing resin or electron beam curing resin may be coated on the matrix, for instance, by spin coating or bar coating. The height of the protruding portions on the resin substrate is preferably 50 to 1000 nm and more preferably 100 to 500 nm. A magnetic layer is provided over the fine pattern on the surface of the resin substrate, thereby obtaining a master information carrier.

Alternatively, a master information carrier may be formed by forming a resin substrate by coating liquefied resin on a matrix carrying thereon an irregularity pattern representing information to be transferred and curing the liquefied resin, forming a magnetic layer on the irregularity pattern of the resin substrate, flattening the back side of the magnetic layer by polishing, forming a flat plate portion on the flattened back side of the magnetic layer by electroforming and peeling a master information carrier, comprising a flat substrate and a magnetic layer, carrying on the surface thereof an irregularity pattern, superposed on the flat substrate, off the resin substrate.

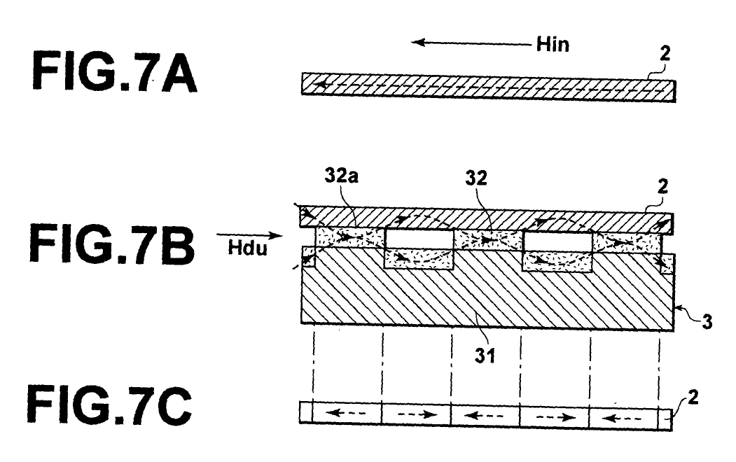

Magnetic transfer to an in-plane magnetic recording medium (a slave medium) will be described with reference to FIGS. 7A to 7C, hereinbelow. The magnetic transfer shown in FIGS. 7A to 7C is of an in-plane recording system.

In FIGS. 7A to 7C, only a magnetic recording area on one side of the slave medium is shown. An initial DC magnetic field Hin is first applied to the slave medium 2 in one direction parallel to the recording tracks thereof, thereby magnetizing the magnetic layer of the slave medium 2 in an initial DC magnetization as shown in FIG. 7A. Thereafter, the protruding portions 32a of the substrate 31 of the master information carrier 3 covered with the magnetic layer 32 is brought into close contact with the slave surface (magnetic recording area) of the slave medium 2. In this state, a transfer magnetic field Hdu is applied in the direction opposite to the initial DC magnetic field Hin as shown in FIG. 7B, thereby magnetically transferring the information on the master information carrier 3 to the slave medium 2. That is, the transfer magnetic field Hdu is absorbed in the magnetic layer 32 on the protruding portions 32a on the master information carrier 3 in close contact with the slave medium 2, and the initial magnetization of the part of the slave medium 2 in contact with the protruding portions 32a of the master information carrier 3 is not reversed but the initial magnetization of the other part of the slave medium 2 is reversed, whereby a magnetization pattern corresponding to a pattern of the protruding portions 32a and the recessed portions on the master information carrier 3 is recorded on (or transferred to) the slave surface (recording tracks) of the slave medium 2.

The information represented by the irregularity patterns on a pair of master information carriers 3 may be transferred to opposite sides of the slave medium 2 either simultaneously or in sequence.

The intensities of the initial magnetic field and the transfer magnetic field should be determined taking into account the coercive force of the magnetic layer of the slave medium 2, the specific permeabilities of the magnetic layers of the master information carrier 3 and the slave medium 2.

In the case of perpendicular recording, a master information carrier 3 substantially the same as that employed in in-plane recording is employed. In the case of perpendicular recording, the magnetic layer of the slave medium 2 is magnetized in advance in a perpendicular direction and a transfer magnetic field is applied to the slave medium 2 and the master information carrier 3 in close contact with each other in the direction opposite to the initial DC magnetic field, whereby the perpendicular magnetization of the part of the slave medium 2 in contact with the magnetic layer 32 of the protruding portions 32a of the master information carrier 3 is reversed, and the magnetic layer of the slave medium 2 is magnetized in a pattern corresponding to the irregularity pattern on the master information carrier 3.

A magnetic recording disc such as a hard disc or a high-density flexible disc provided with a magnetic layer on one side or each side thereof is generally employed as the slave medium 2. The magnetic recording area thereof is generally of a coated magnetic layer or a metal film type magnetic layer. In the case of a slave medium having a magnetic layer of metal film, the material of the magnetic layer may be Co, Co alloy (e.g., CoPtCr, CoCr, CoPtCrTa, CoPtCrNbTa, CoCrB, CoNi, Co/Pd), Fe or Fe alloy (e.g., FeCo, FePt, FeCoNi). These materials are preferred in view of obtaining clearer magnetic transfer since the magnetic layer of these materials is higher in magnetic flux density. It is further preferred that the magnetic layer of the slave medium 2 be provided with a non-magnetic primer layer on the substrate side thereof in order to give the magnetic layer a necessary magnetic anisotropy. The primer layer should match to the magnetic layer in crystallographic structure and lattice constant. For this purpose, Cr, CrTi, CoCr, CrTa, CrMo, NiAl, Ru or the like may be employed as the non-magnetic primer layer.

The magnetic field application means for applying the initial magnetic field and the transfer magnetic field comprises, for instance, a pair of ring type electromagnets each disposed on one side of the slave medium 2 and the master information carrier 3 in a close contact with each other. Each of the electromagnets comprises a core having a gap extending in a radial direction of the slave medium 2 and a winding wound around the core. In the case of the in-plane recording, the ring type electromagnets on opposite sides of the slave medium 2 and the master information carrier 3 in a close contact with each other applies magnetic fields in the same direction in parallel to the tracks. The magnetic field application means applies a magnetic field to the slave medium 2 and the master information carrier 3 while rotating the slave medium 2 and the master information carrier 3 in a close contact with each other. Instead of rotating the slave medium 2 and the master information carrier 3, the magnetic field application means maybe rotated. A ring type electromagnet may be disposed only on one side of the slave medium 2 and the master information carrier 3 or on each side of the same. A permanent magnet may be employed in place of the electromagnets.

In the case of the perpendicular recording, a pair of electromagnets or a permanent magnets different in polarity are disposed on opposite sides of the holder so that a magnetic field is generated in perpendicular to the tracks. When the magnetic field application means is of a type which applies a magnetic field only a part of the slave medium 2 and the master information carrier 3, the assembly of the slave medium 2 and the master information carrier 3 and the magnetic field are moved with respect to each other so that a magnetic field is applied to the slave medium 2 and the master information carrier 3 over the entire area thereof.

A method of producing an optical disc stamper involving a method of depicting elements in accordance with another embodiment of the present invention will be described, hereinbelow.

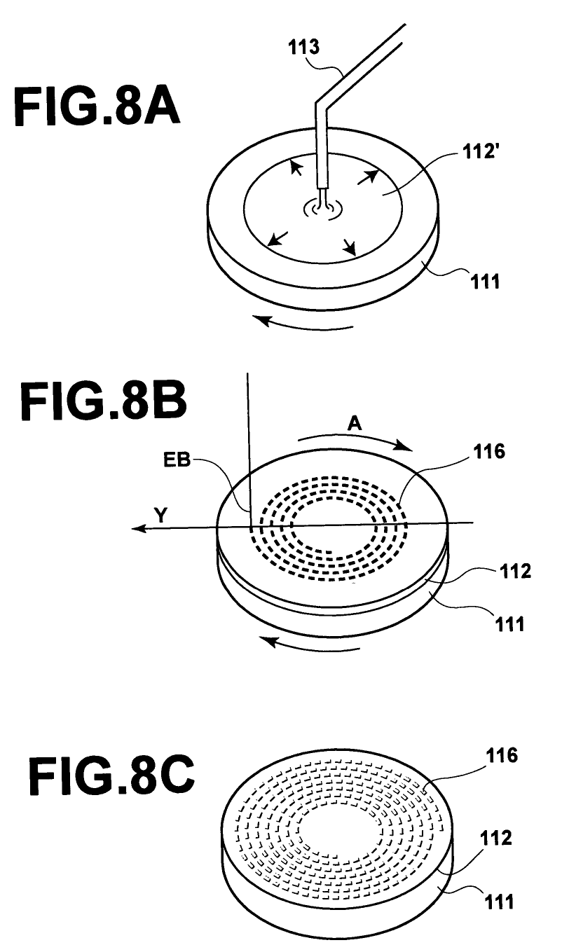

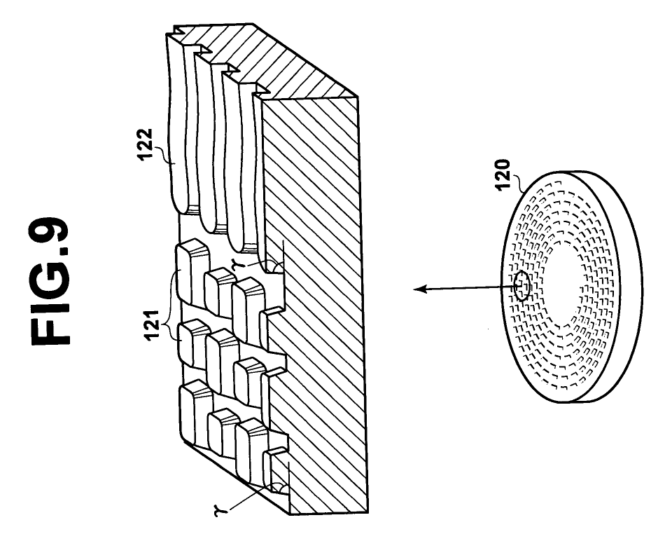

FIGS. 8A to 8C are views for illustrating formation of an irregularity pattern on a matrix for producing an optical disc stamper, and FIG. 9 is a view showing the optical disc stamper and showing a part of the same in an enlarged scale.

As shown in FIG. 9, the optical disc stamper 120 is provided on its surface with an irregularity pattern formed of helically arranged pit forming portions 121 and groove forming portions 122, which are protruding. The shapes of the upper surfaces of the pit forming portions 121 and the groove forming portions 122 form a desired pattern to be depicted in accordance with the method of the present invention.

As shown in FIG. 8A, for example, a resist solution 112′, comprising electron beam drawing resist 112 dissolved in organic solvent, is applied to a disc-like substrate 111 of silicon by spin coating from a nozzle 113 while rotating the disc-like substrate 111 in one direction and then the substrate 111 is baked. In place of the disc-like substrate 111 of silicon, a disc-like substrate of glass provided with conductive film may be employed.

Thereafter, as shown in FIG. 8B, an electron beam EB modulated according to data representing lengths of pits (or grooves) is caused to scan the disc-like substrate 111 carrying thereon the resist 112 while rotating the substrate 111 in the direction of arrow A, thereby depicting a desired pattern. By substantially continuously moving the stage 41 in the direction of arrow Y while rotating the same in the direction of arrow A, a helical pattern (a pattern of the helically arranged pit forming portions and groove forming portions and the like) 116 is depicted. The beam diameter of the electron beam EB on the resist 112 is smaller than the minimum width of the pattern, a pattern 116 corresponding to the upper surfaces of the pit forming portions, grooves and the like is depicted in the same manner as described above in conjunction with production of the substrate for a master information carrier for magnetic transfer. Since the groove forming portions shown in FIG. 9 are for forming wobble grooves, for instance, the amplitudes of the electron beam EB is varied to provide desired wobble.

Then, as shown in FIG. 1C, the electron beam drawing resist 112 is developed and a silicon disc-like substrate 111 on which a helical desired pattern 116 is drawn is obtained. The substrate 111 makes a matrix on the basis of which a plurality of optical disc stampers are duplicated.

By the use of an optical disc stamper thus produced, a plurality of optical discs are duplicated.

The trajectory of the electron beam during depiction of the elements depends upon the periodic functions employed, and since the amount of exposure of the resist at ends of the elements depends upon the trajectory of the electron beam during depiction of the elements, the rising angle of the protruding portions (indicated at γ in FIG. 9) depends upon the periodic functions employed. It is believed that the rising angle γ affects the reproduction properties. In the conventional technology, where the elements are depicted with a laser beam, the rising angle γ of the protruding portions cannot be changed since the shape of the protruding portions is governed by the diameter of the laser beam. Whereas, in accordance with this embodiment where an electron beam smaller than the minimum width of the pit forming portions or the groove forming portions in its beam diameter is used, the rising angle γ of the protruding portions can be a desired angle. Accordingly, the periodic functions are selected so that the reproduction properties of the optical disc is optimal.

A method of producing a pattered medium involving a method of depicting elements in accordance with still another embodiment of the present invention will be described, hereinbelow.

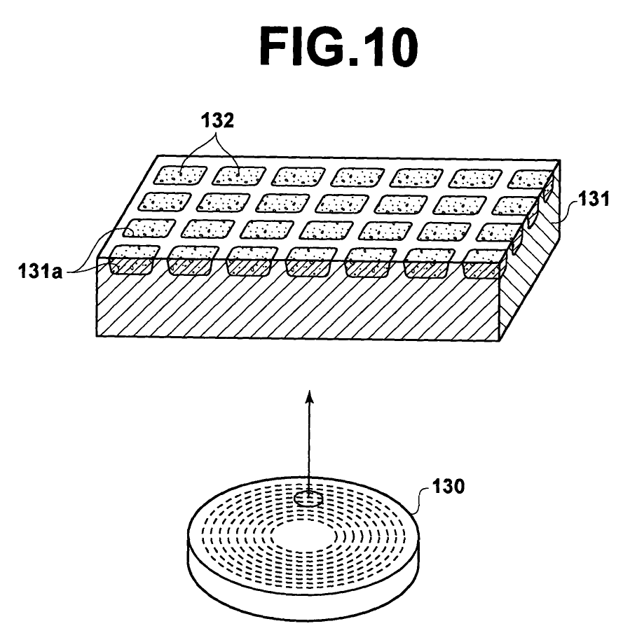

As shown in FIG. 10, a patterned medium 130 comprises a disc-like substrate 131 on the surface of which a plurality of rectangular recessed portions 131a are regularly arranged along concentric tracks and magnetic material 132 embedded in each of the recessed portions 131a. The pattern of the recessed portions 131a is the pattern to be depicted and the shape of the opening of each recessed portion 131a is the element forming the pattern. The pattern of the recessed portions 131a is depicted by the method of the present invention, and the substrate 131 provided with recessed portions is prepared and, then magnetic material is embedded in each of the recessed portions 131a.

More particularly, resist layer is formed on the substrate 131 and the pattern of the recessed portions 131a is depicted on the resist layer in the same manner as described above in conjunction with production of the substrate for a master information carrier for magnetic transfer. Thereafter, the resist layer is developed to form an irregularity pattern of resist on the surface of the substrate 131, and the surface of the substrate 131 is etched and magnetic material is deposited on the etched part of the surface of the substrate 131 with the resist left on the surface of the substrate 131 used as a mask. The resist left on the surface of the substrate 131 is subsequently is lifted off to leave a patterned medium shown in FIG. 10 as disclosed, for instance, in Japanese Unexamined Patent Publication No. 2001-110050. The substrate having an irregularity pattern on the surface thereof may be formed by first forming a matrix having an irregularity pattern on the surface thereof and subsequently carrying out electroforming on the matrix in the same manner as described above in conjunction with production of the substrate for a master information carrier for magnetic transfer. The patterned medium need not be in the form where magnetic material 132 is embedded but may be in the form where protruding portions of magnetic material are regularly arranged on the surface of a flat substrate.

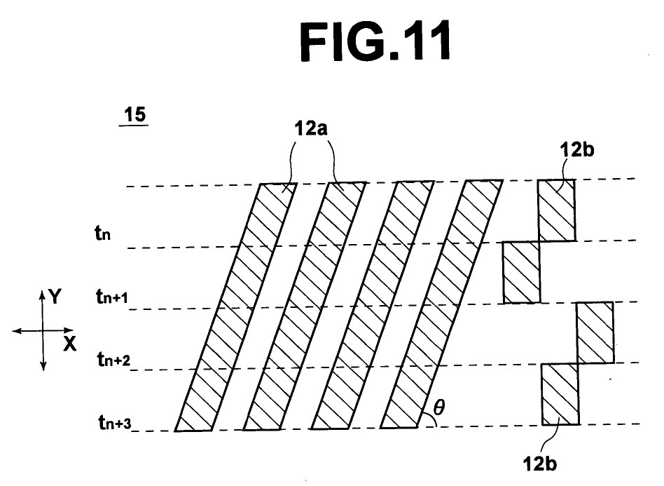

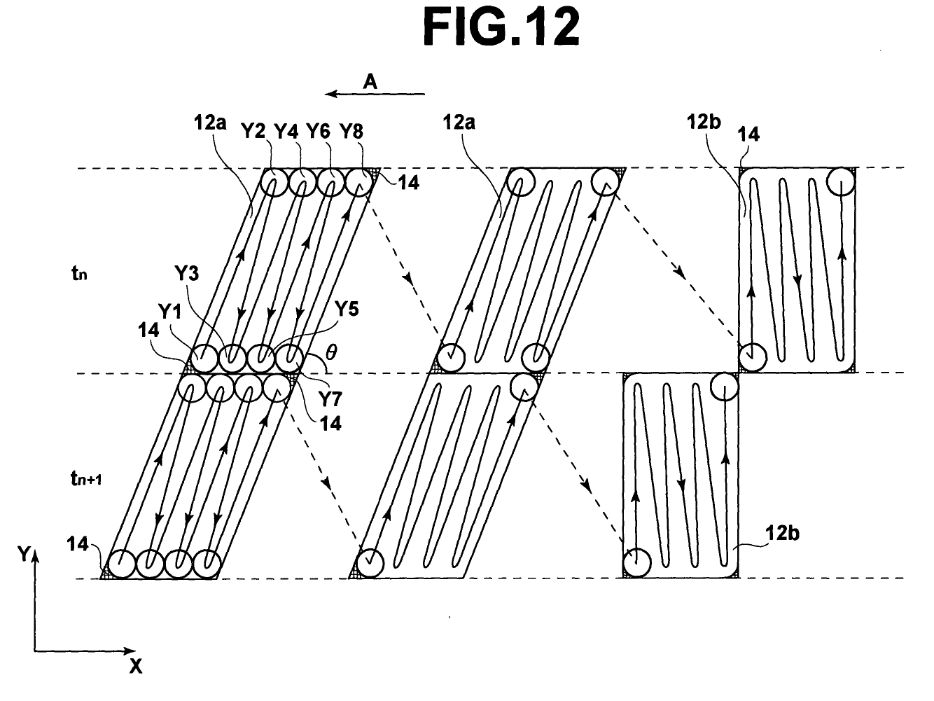

Still another embodiment of the present invention will be described with reference to FIGS. 11 and 12, hereinbelow. This embodiment is for producing a master information carrier for magnetic transfer and differs from the previous embodiment only in the irregularity pattern. Accordingly, the elements analogous to those shown in FIGS. 1A to 7C are given the same reference numerals and description will be made only on depiction of the irregularity pattern.

As shown in FIG. 11, the irregularity pattern includes elements 12a which are parallelograms in shape and obliquely extend over a plurality recording tracks tₙ to tₙ₊₃ intersecting the direction X of the recording tracks at an angle θ and elements 12b which are rectangular in shape and extend in perpendicular to the direction of recording tracks within one track width.

The elements 12a are drawn by dividing each of the elements 12a into a plurality of parallelogram sections each in one track, and by repeating depictions of the parallelogram sections. Each parallelogram section is depicted in the same manner as described above in conjunction with FIGS. 2, 4 and 5. That is, each parallelogram section is depicted, for instance, by periodically oscillating the electron beam EB in a predetermined direction at a predetermined amplitude by driving the Y-direction deflector means 21 and the X-direction deflector means 22 in synchronization with each other by periodic function signals such as of a sine wave while rotating the disc-like substrate 11 in the direction of arrow A so that the electron beam EB scans the resist 12 on the disc-like substrate 11 in parallel to the slant sides of the element 12a at angle θ to the direction of arrow A.

That is, the electron beam EB is caused to scan the resist 12 from point Y1 to point Y2, from point Y2 to point Y3, from point Y3 to point Y4 • • • in sequence and one parallelogram section is thus depicted. At this time, the Y-direction deflector means 21 and the X-direction deflector means 22 are controlled to control the direction in which the electron beam EB is oscillated. The rotating speed of the disc-like substrate 11 is controlled so that the point on which the electron beam EB is projected is moved from point Y1 to point Y3 in one cycle of the oscillation of the electron beam EB, and the direction in which the electron beam EB is oscillated is determined taking into account the movement of the point on which the electron beam EB is projected in X-direction due to rotation of the disc-like substrate 11. At point Y8, projection of the electron beam EB is cut and then adjacent parallelogram section in the same track is depicted in the same manner. Thereafter, adjacent rectangular element 12b is depicted. After a pattern for one recording track is depicted, the rotary stage unit 45 is moved in Y-direction and a pattern for the adjacent recording track is depicted.

The elements 12a which are parallelograms in shape and obliquely extend over a plurality recording tracks intersecting the direction X of the recording tracks are depicted by incorporating a plurality of parallelogram sections each in one track into a large parallelogram.

What is claimed is:

1. A method of exposing a resist layer formed on a disc-like substrate to an electron beam in a desired pattern to depict a desired pattern on the resist layer wherein the improvement comprises that
the desired pattern is depicted by oscillating back and forth, in directions intersecting the circumferential direction of the disc-like substrate, an electron beam smaller in its beam diameter than the minimum width of the pattern while rotating the substrate in one direction.

2. A method as defined in claim 1 in which the disc-like substrate is a substrate for producing a master information carrier for magnetic transfer.

3. A method as defined in claim 2 in which the master information carrier carries on its substrate an irregularity pattern formed of a pattern of protruding portions and the recessed portions representing information to be transferred to a slave medium.

4. A method as defined in claim 3 in which the information to be transferred to the slave medium includes a servo signal.

5. A method as defined in claim 2 in which a magnetic layer is formed on the upper surface of the protruding portions.

6. A method as defined in claim 2 in which a magnetic layer is formed on the upper surface of the protruding portions and the bottom of the recessed portions.

7. A method as defined in claim 1 in which the disc-like substrate is a substrate for producing an optical disc stamper.

8. A method as defined in claim 1 in which the disc-like substrate is a substrate for producing a patterned medium for high-density magnetic recording.

9. A disc-like substrate for high-density recording produced by procedure including the steps of exposing a resist layer formed on the disc-like substrate to an electron beam in a desired pattern to depict a desired pattern on the resist layer and forming an irregularity pattern, wherein the improvement comprises that
the desired pattern is depicted by oscillating back and forth, in directions intersecting the circumferential direction of the disc-like substrate, an electron beam smaller in its beam diameter than the minimum width of the pattern while rotating the substrate in one direction.

10. A disc-like substrate as defined in claim 10 in which the disc-like substrate is a substrate for producing a master information carrier for magnetic transfer.

11. A disc-like substrate as defined in claim 10 in which the master information carrier carries on its substrate an irregularity pattern formed of a pattern of protruding portions and the recessed portions representing information to be transferred to a slave medium.

12. A disc-like substrate as defined in claim 11 in which the information to be transferred to the slave medium includes a servo signal.

13. A disc-like substrate as defined in claim 11 in which a magnetic layer is formed on the upper surface of the protruding portions.

14. A disc-like substrate as defined in claim 11 in which a magnetic layer is formed on the upper surface of the protruding portions and the bottom of the recessed portions.

15. A disc-like substrate as defined in claim 9 in which the disc-like substrate is a substrate for producing an optical disc stamper.

16. A disc-like substrate as defined in claim 9 in which the disc-like substrate is a substrate for producing a patterned medium for high-density magnetic recording.

17. A method of producing a master information carrier for magnetic transfer having a substrate provided with an irregularity pattern formed of a plurality of elements at least one of which extends over a plurality of recording tracks intersecting the direction of the recording tracks, wherein the improvement comprises that
production of said substrate comprises the step of exposing a resist layer formed on a disc-like substrate to an electron beam to depict shapes of the upper surfaces of the elements, and
the shapes of the upper surfaces of the elements are depicted by parts in each of the recording tracks by oscillating back and forth, in directions intersecting the circumferential direction of the disc-like substrate, an electron beam smaller in its beam diameter than the minimum width of the pattern while rotating the substrate in one direction.

18. A method as defined in claim 17 in which the substrate carries an irregularity pattern formed of a pattern of protruding portions and the recessed portions representing information to be transferred to a slave medium.

19. A method as defined in claim 18 in which the information to be transferred to the slave medium includes a servo signal.

20. A method as defined in claim 18 in which a magnetic layer is formed on the upper surface of the protruding portions.

21. A method as defined in claim 20 in which the magnetic layer is formed of soft magnetic material.

22. A method as defined in claim 20 in which the magnetic layer is formed of semi-hard magnetic material.

23. A method as defined in claim 18 in which a magnetic layer is formed on the upper surface of the protruding portions and the bottom of the recessed portions.

24. A method as defined in claim 23 in which the magnetic layer is formed of soft magnetic material.

25. A method as defined in claim 23 in which the magnetic layer is formed of semi-hard magnetic material.
